(19) United States
(12) Patent Application Publication
(10) Pub. No.: US 2014/0039445 A1
(43) Pub. Date: Feb. 6, 2014

(54) COMPUTER-BASED REUSABLE BIDIRECTIONAL MEDICAL ADHERENCE SYSTEM AND METHOD FOR PERSONALIZED MEDICATION PACKAGING

(71) Applicants: Paul R. Austin, Webster, NY (US); Wendell Lewis Kibler, Rochester, NY (US); Claude S. Fillion, Rochester, NY (US)

(72) Inventors: Paul R. Austin, Webster, NY (US); Wendell Lewis Kibler, Rochester, NY (US); Claude S. Fillion, Rochester, NY (US)

(73) Assignee: XEROX CORPORATION, Norwalk, CT (US)

(21) Appl. No.: 13/567,630

(22) Filed: Aug. 6, 2012

(51) Int. Cl. A61J 1/18

(52) U.S. Cl. 604/404

(57) ABSTRACT

A computer-based system for implementing and monitoring a medication regimen, including a medication package and a computer-based unit. The package includes a base including spaces for receiving a medication, a sheet of material including respective portions sealing the spaces with respect to the base, and a respective electrical circuit associated with each portion. The computer-based unit includes a memory element to store computer readable instructions and a medication regimen, formulated by a medical practitioner or pharmacist, for the medication, a processor; and a wireless transmitter. The computer-based unit is attachable to the medication package or can wirelessly communicate with the medication package. The processor executes the computer readable instructions to: monitor the electrical circuits to detect when portions are ruptured; and wirelessly transmit, using the wireless transmitter, a compliance message for receipt by at least one computer, the compliance message indicating whether a portion has been ruptured.

### TECHNICAL FIELD

The present disclosure relates to a computer-based system and method including a medication package and computer-based unit for monitoring when spaces in the package containing medication are accessed. The computer-based unit wirelessly transmits compliance messages regarding access to the spaces.

### BACKGROUND

It is estimated that up to ⅔ of medications prescribed in the United States are not taken or are improperly taken (for example, dosages reduced by the patient). As a result, medical conditions that would otherwise be controlled or cured by the prescribed medications remain untreated resulting in worsening of the conditions and increased medical intervention such as visits to medical practitioners, hospitalization, or emergency room visits. In some cases patients that otherwise could remain at home are hospitalized solely to administer and control a medication regimen. Such medical intervention and hospitalization worsen the quality of life for the patient and results in increased medical expenditures.

At present there is no automated means of communication between a medical practitioner or pharmacist and a patient regarding compliance of the patient with a medication regimen prescribed by the practitioner and supplied by the pharmacist. Such communication is limited to communication initiated by the patient (calling the practitioner) or provided during medical visits. Thus, there is virtually no real time communication or feedback between the patient and the practitioner or pharmacist and no real time means for dynamically modifying a medication regimen, for example, modifying a schedule for taking a medication or a dosage of the medication to maximize effectiveness of the medication and reduce side-effects of the medication.

U.S. Pat. No. 4,616,316 teaches a system with a blister pack and a memory circuit for recording usage of the blister pack. The memory circuit can be connected to a processor to download compliance data stored in the memory circuit, for example, during a visit to a medical practitioner's office. However, the system does not provide automatic real time communication to a provider or pharmacist, does not provide real time feedback to the patient, and does not enable dynamic changes to a medical regimen using the blister pack.

U.S. Pat. No. 7,336,564 teaches a system with a blister pack and a device for holding the blister pack. The system provides alerts, set by the user, as to when medication should be taken. However, the system does not provide automatic real time communication to a provider or pharmacist, does not provide real time feedback to the patient, and does not enable dynamic changes to a medical regimen using the blister pack.

It is known to use an automatic medication dispenser, such as provided by epill LLC. Such devices can provide medications at intervals programmed by the user (patient). These devices sound an alarm and notify a caregiver if the patient does not manipulate the device to release a pill. However, the device does not provide a means of confirming whether the patient has taken the pill and provides no feedback to a medical practitioner or pharmacist regarding compliance with a regimen. Thus, adjustments to the regimen, for example due to missed dosages, cannot be made by the medical practitioner. Any adjustments to the regimen are made at the device by the patient.

It is known to provide reminders regarding a medication regimen via a “MediMemory” application for an iPhone. The application provides reminder calls to a patient's iPhone and can track usage. However, the patient must provide the information used by the application. The application does not receive input from a medical practitioner or provide feedback to a medical practitioner. Thus, the application does not provide any means of dynamically adjusting the regimen.

It is known to provide scheduled calls to senior citizens, for example through the CARE Call Reassurance® system of database systems corp. However, the calls are designed merely to enable a general response regarding the well being of the person receiving the call and have no functionality regarding the medication regimen aspects discussed above.

At present, the provision of mediation regimens tends to be “practitioner-centric” rather than “patient-centric.” That is, the focus of care and recordkeeping tends to be within the respective spheres of the various practitioners involved in care of a patient. Stated otherwise, retail distribution of medications is focused on what is good for the medical practitioner or pharmacist rather than the customer. For example, since medications can interfere with each other, it is important to define a regimen that minimizes interactions when multiple medications are defined. Such regimens are often confusing for a patient to understand and adhere to. Typically, instructions are printed on a medication container label and a pharmacist will offer to review these instructions the first time the medication is purchased. However, a non-institutional patient is left to his or her own initiative to take the medication and otherwise comply with a medication regimen.

As another example of a “practitioner-centric” system, medical treatment and practitioners are highly specialized and channels of communication among practitioners, for example, regarding a medication regimen for a patient, are typically not automatic or easily accessed or used. For example, changes to a medication regimen for a patient made by one practitioner are not automatically registered in the medical record system for another practitioner providing care to the patient. In particular, such changes are not made available in real time.

### SUMMARY

According to aspects illustrated herein, there is provided a computer-based system for implementing and monitoring a medication regimen, including a medication package and a computer-based unit. The package includes a base including a plurality of spaces for receiving at least one medication, a sheet of material including respective portions sealing the plurality of spaces with respect to the base, and a respective electrical circuit associated with each respective portion. The computer-based unit includes a memory element configured to store first computer readable instructions and a medication regimen, formulated by a medical practitioner or pharmacist, for the at least medication, a processor; and a wireless transmitter. The computer-based unit is attachable to the medication package or can wirelessly communicate with the medication package. The processor is configured to execute the first computer readable instructions to: monitor the respective electrical circuits to detect when the respective portions are ruptured; and wirelessly transmit, using the wireless transmitter, a compliance message for receipt by at least one computer, the compliance message indicating whether a respective portion has been ruptured.

According to aspects illustrated herein, there is provided a computer-based method for implementing and monitoring a medication regimen, including: storing in a memory element for a computer-based unit, first computer readable instructions and a medication regimen, formulated by a medical practitioner or pharmacist, for the at least medication; sealing, with respective portions of a sheet of material, the at least one medication in a plurality of spaces in a base for a medication package; associating respective electrical circuits with the respective portions; and executing, using a processor for the computer-based unit, the first computer readable instructions to: monitor the respective electrical circuits to detect when the respective portions are ruptured; and wirelessly transmit, using a wireless transmitter for the computer-based unit, a compliance message for receipt by at least one computer, the compliance message indicating whether a respective portion has been ruptured.

According to aspects illustrated herein, there is provided a computer-based system for implementing and monitoring a medication regimen, including a medication package and a computer-based unit. The package includes a base including a plurality of spaces for receiving at least one medication, a sheet of material including respective portions sealing the plurality of spaces with respect to the base, and a respective electrical circuit associated with each respective portion. The computer-based unit includes a memory element configured to store first computer readable instructions, a processor, and a wireless transmitter and receiver. The computer-based unit is attachable to the medication package or can wirelessly communicate with the medication package. The processor is configured to execute the first computer readable instructions to: receive, using the receiver, a medication regimen for the at least one medication formulated by a medical practitioner or pharmacist and including a schedule with respective times for taking the at least one medication enclosed in respective specified spaces; store the medication regimen in the memory element; monitor the respective electrical circuits to detect, in real time, when the respective portions are ruptured; and wirelessly transmit in real time, using the wireless transmitter, a compliance message for receipt by at least one computer, the compliance message information as to whether the respective portion was ruptured according to the schedule.

According to aspects illustrated herein, there is provided a computer-based method for implementing and monitoring a medication regimen, including: storing in a memory element for a computer-based unit, first computer readable instructions and a medication regimen, formulated by a medical practitioner or pharmacist, for the at least medication, the medication regimen including instructions regarding the at least one first medication; sealing, with respective portions of a sheet of material, the at least one medication in a plurality of spaces in a base for a medication package; associating respective electrical circuits with the respective portions; and executing, using a processor for the computer-based unit, the first computer readable instructions to: express, using a user interface for the computer-based unit, a first message based on the instructions; receive, using a wireless receiver for the computer-based unit, a transmission from at least one computer; modify the instructions according to the transmission; express, using the user interface, a second message based on the modified instructions; monitor the respective electrical circuits to detect when the respective portions are ruptured; and wirelessly transmit, using a wireless transmitter for the computer-based unit, a compliance message for receipt by the at least one computer, the compliance message indicating whether a respective portion has been ruptured.

### BRIEF DESCRIPTION OF THE DRAWINGS

Various embodiments are disclosed, by way of example only, with reference to the accompanying schematic drawing in which corresponding reference symbols indicate corresponding parts, in which:

FIGS. 1A and 1B are a schematic block diagram of a computer-based reusable bidirectional medical adherence system for personalized medication packaging;

FIG. 2 is a schematic block cross section of a base shown in FIGS. 1A and 1B generally along line 2-2 in FIGS. 1A and 1B;

FIG. 3 is a schematic block diagram of a computer-based system for implementing and monitoring compliance with a medication regimen usable with the system of FIGS. 1A and 1B; and,

FIG. 4 is a pictorial representation of an example medication package for the computer-based reusable bidirectional medical adherence system for personalized medication packaging of FIGS. 1A and 1B.

### DETAILED DESCRIPTION

Moreover, although any methods, devices or materials similar or equivalent to those described herein can be used in the practice or testing of these embodiments, some embodiments of methods, devices, and materials are now described.

The following non-limiting definitions are applicable to the present invention:

1. Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

2. Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

3. Real time: For human interactions we mean that the time span between a triggering event and an activity in response to that event is minimized. In a computer context we mean that data manipulation and/or compensation which occurs with little or no use of a processor, thereby resulting in efficient data manipulation and/or compensation without added processor overhead, such as delaying raw data transmission without any computational analysis of the same, while “raw data” and “raw print data” are intended to mean data which has not been modified from its original form and sequence. For example, as described below, a patient is able to immediately report on compliance with a medication regimen in response to a message and the compliance information is immediately transmitted to a computer for a prescribing medical practitioner.

4. Wireless Communications Device (WCD)—A communications device that transmits and receives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, 3G, and 4G.

It should be understood that the use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B.

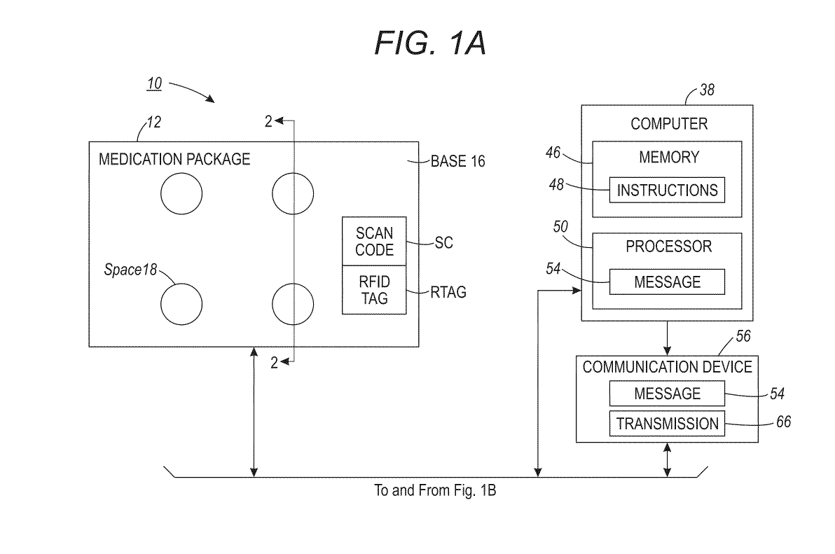

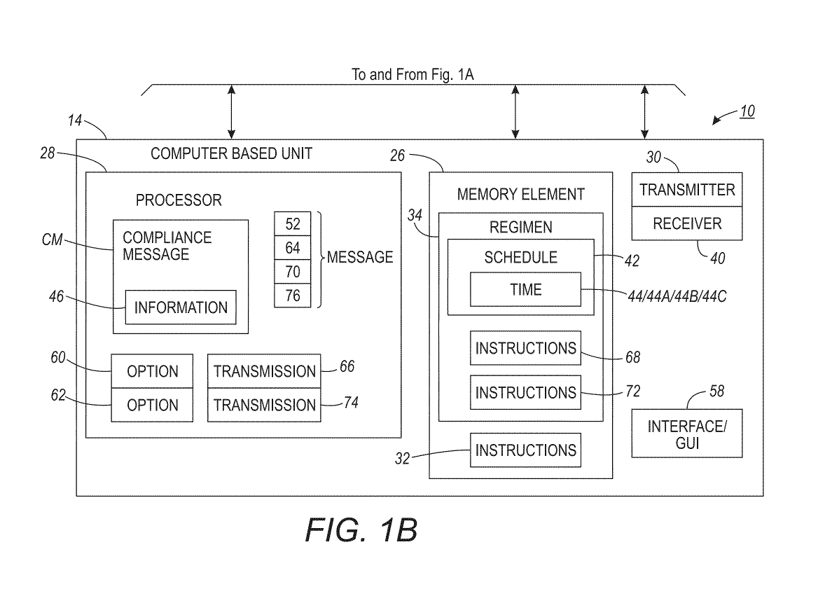

FIGS. 1A and 1B are a schematic block diagram of computer-based reusable bidirectional medical adherence system 10 for personalized medication packaging.

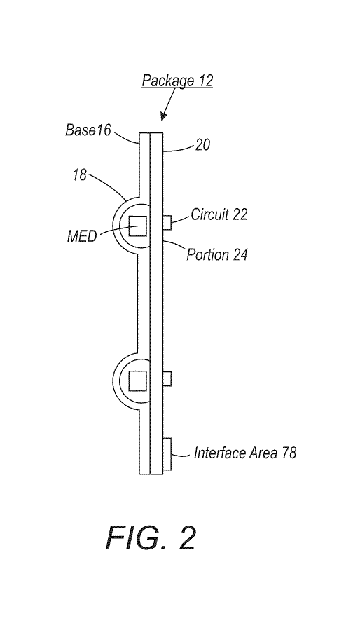

FIG. 2 is a schematic block cross section of a base shown in FIGS. 1A and 1B generally along line 2-2 in FIGS. 1A and 1B. The following should be viewed in light of FIGS. 1A through 2. System 10 includes medication package 12 and computer-based unit 14. Package 12 includes base 16 with spaces 18, sheet 20 of material, and one or more electrical circuits 22. In an example embodiment, base 16 is a blister pack as known in the art. Base 16 is not limited to any particular size, number, or configuration of spaces 18. Spaces 18 are for receiving at least one medication MED. It should be understood that MED is not limited to a particular type, configuration, or number of medications. Sheet 20 includes portions 24 sealing the plurality of spaces with respect to the base. Circuits 22 are associated with portions 24, for example, respective circuit pass through or over portions 24. In an example embodiment, a single circuit is associated with all of the portions. In an example embodiment, the base includes more than one circuit and the respective circuits are associated with multiple respective portions. In an example embodiment, there is a separate circuit for each portion. The discussion below assumes a separate circuit for each portion.

Unit 14 includes memory element 26, processor 28, and wireless transmitter 30. The memory element is configured to store computer readable instructions 32 and medication regimen 34, formulated by a medical practitioner or pharmacist for a patient taking MED. Unit 14 is attachable to the medication package, or can wirelessly communicate with the at least one medication package. Processor 28 is configured to execute computer readable instructions 32 to monitor circuits 22 to detect when respective portions 24 are ruptured and wirelessly transmit, using transmitter 30, compliance message CM for receipt by least one computer 38. The compliance message at least indicates whether a respective portion 24 has been ruptured. In an example embodiment, computer 38 is associated with the medical practitioner, the pharmacist, or a designated care giver for a patient for whom MED is prescribed.

In an example embodiment, processor 28 detects, in real time, whether a respective portion has been ruptured and transmits message CM in real time. Thus, vital information regarding compliance is captured and transmitted as soon as the information is made available, for example, as soon as a rupture is detected, or as soon as a designated time period has elapsed in which a designated portion has not been ruptured. Such real time operation enables the quickest, most medically-effective, and most cost-effective data analysis and possible reactions to possible non-compliance issues. Such reactions can include, but are not limited to, modifying the medical regimen or otherwise instructing the patient. Thus, efficacy of the regimen is optimized and negative consequences of non-compliance are minimized.

In an example embodiment, unit 14 includes wireless receiver 40 and processor 28 is configured to execute computer readable instructions 32 to receive, using the wireless receiver, the medication regimen and to store the medication regimen in memory element 26. In an example embodiment, the medication regimen is encoded on a medication package, for example on a surface of medication package 12, and processor 28 is configured to execute computer readable instructions CM to download the encoded medication regimen from the medication package and store the medication regimen in the memory element 26. For example, package 16 includes scan code SC or radio frequency identification tag RTAG including the medication regimen and unit 14 is configured to read SC and RTAG to download the medication regimen.

In an example embodiment, the medication regimen includes schedule 42 with respective times 44 for taking MED enclosed in respective specified spaces 18, and the compliance message includes information 46 as to whether the respective portion was ruptured according to the schedule. In an example embodiment, information 46 indicates whether: the respective portion was ruptured for a correct respective space 18 and at a correct time 44A according to the schedule; the respective portion 24 was ruptured prior to a time 44B according the schedule; the respective portion 24 was ruptured after a time 44C according to the schedule; or the respective portion was for an incorrect portion 24 according to the schedule. In an example embodiment, prior to time 44B indicates taking MED sooner than directed according to the schedule; after time 44C indicates taking MED later than directed according to the schedule; incorrect space 18 indicates an incorrect configuration of MED. In general, an incorrect configuration means that some incorrect combination of type or dosage of medications has been accessed. For example, the type or dosage of medication included in a space sealed by the incorrect portion 24 is not prescribed for time 44A.

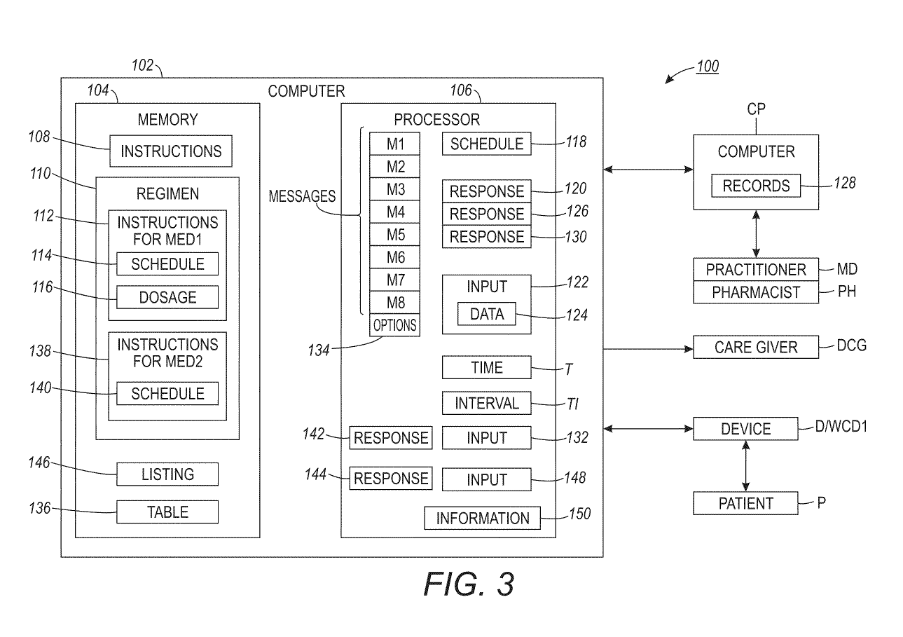

FIG. 3 is a schematic block diagram of computer-based system 100 for implementing and monitoring compliance with a medication regimen usable with system 10 of FIGS. 1A and 1B. The following should be viewed in light of FIGS. 1 through 3. In an example embodiment, computer 38 includes memory element 46 configured to store computer readable instruction 48 and processor 50 configured to execute instructions 48. In an example embodiment, computer 38, memory element 46, instructions 48, and processor 50 are computer 102, memory element 104, instructions 108, and processor 106 in system 100. The discussion that follows assumes computer 38, memory element 46, instructions 48, and processor 50 are computer 102, memory element 104, instructions 108, and processor 106 in system 100.

In an example embodiment, processor 28 is configured to execute computer readable instructions 32 to transmit message 52 to computer 102 in response to one or more of the following conditions: a respective portion 24 was ruptured for a correct respective space 18 and at correct time 44A according to schedule 42; a respective portion 24 was ruptured prior to time 44B according the schedule; a respective portion 24 was ruptured after time 44C according to the schedule; or a respective portion 24 was for an incorrect portion 24 according to the schedule. Processor 106 is configured to execute computer readable instructions 108 to receive message 52 and transmit, in response to receiving message 52, message 54. Message 54 is regarding non-compliance with respect to the schedule and is transmitted to communications device 56 accessible by a patient for whom MED has been prescribed. Thus, system 10 is able to contact the patient in real time when a non-compliance with regimen 34 occurs. Device 56 can be any communication device known in the art, including, but not limited to a WCD, a computer, or a land line telephone.

In an example embodiment, unit 14 includes user interface 58, for example, graphical user interface (GUI) 58. Interface or GUI 58 can be any interface or GUI known in the art. In an example embodiment, processor 28 is configured to execute computer readable instructions CM to provide option 60 to request assistance or option 62 informing the medical practitioner or pharmacist of a lack of desire or inability to take MED. In an example embodiment, options 60 and 62 are provided on a constant, on-going basis (the patient is able to select the options at any time). In an example embodiment, options 60 and 62 are provided at specific times or the availability of these options is highlighted at these specific time. The specific times include, but are not limited to when: a respective portion 24 was ruptured prior to time 44B according the schedule; a respective portion 24 was ruptured after a time 44C according to the schedule; or a respective portion 24 was for an incorrect portion 24 according to the schedule. Processor 28 is configured to execute computer readable instructions 32 to receive, using the user interface, election of one or both of options 60 and 62 and transmit, using the wireless transmitter, message 64 including the selected option or options to computer 102. Options 60 and 62 can be provided by any means known in the art, including but not limited to, visual means, audio means, or tactile means.

Option 60 can be customized to reflect specifics of regimen 34 and MED or specifics of a patient's medical condition, environment, preferences, or schedules. Option 60 can include a plurality of requests for example, requests for: information regarding dosage or schedule for MED, or information regarding side effects. Option 62 can include a plurality of possible messages including, but not limited to: reasons why the patient cannot or will not take MED.

In an example embodiment, processor 28 is configured to execute computer readable instructions 32 to receive transmission 66 from computer 102 in response to transmitting message 64 and express, using the user interface, transmission 66. Transmission 66 includes information in response to the selection of options 60 or 62, for example: requested information regarding dosage, schedule, or side effects; instructions for proceeding following non-compliance with regimen 34; or further instructions for obtaining assistance. In an example embodiment, message 64 is expressed using interface or GUI 58 by any means known in the art, including but not limited to, visual means, audio means, or tactile means. In an example embodiment, transmission 66 is sent to communications device 56.

In an example embodiment, the medication regimen includes instructions 68 regarding MED, for example, instructions regarding dosage, schedule, or interactions. Processor 28 is configured to execute computer readable instructions CM to express, using the user interface, message 70 based on the instructions, for example, expressing the instructions regarding dosage or schedule, by any means known in the art, including but not limited to, visual means, audio means, or tactile means. In an example embodiment, processor 28 is configured to execute computer readable instructions CM to express, using the user interface, message 70 according to schedule 42 and times 44 by any means known in the art, including but not limited to, visual means, audio means, and tactile means.

In an example embodiment, the medication regimen includes instructions 72 regarding MED and processor 28 is configured to execute computer readable instructions CM to: receive, using the wireless receiver, transmission 74 from computer 102 and modify instructions 72 according to the transmission. Thus, system 10 provides a real time means of automatically modifying a medication regimen without requiring any effort or activity by the patient, such as visiting a medical practitioner's office or even calling a medical practitioner. In an example embodiment, processor 28 is configured to execute computer readable instructions 32 to express, using the user interface, message 76 based on modified instructions 72, by any means known in the art, including but not limited to, visual means, audio means, and tactile means. Thus, system 10 further provides an automatic, real time means of notifying a patient of changes in the medical regimen to help ensure on-going compliance with the regimen.

In an example embodiment, processor 28 is configured to execute computer readable instructions CM to wirelessly transmit, using wireless transmitter 30, compliance message CM to electronic medical records system 128 for the medical practitioner or pharmacist.

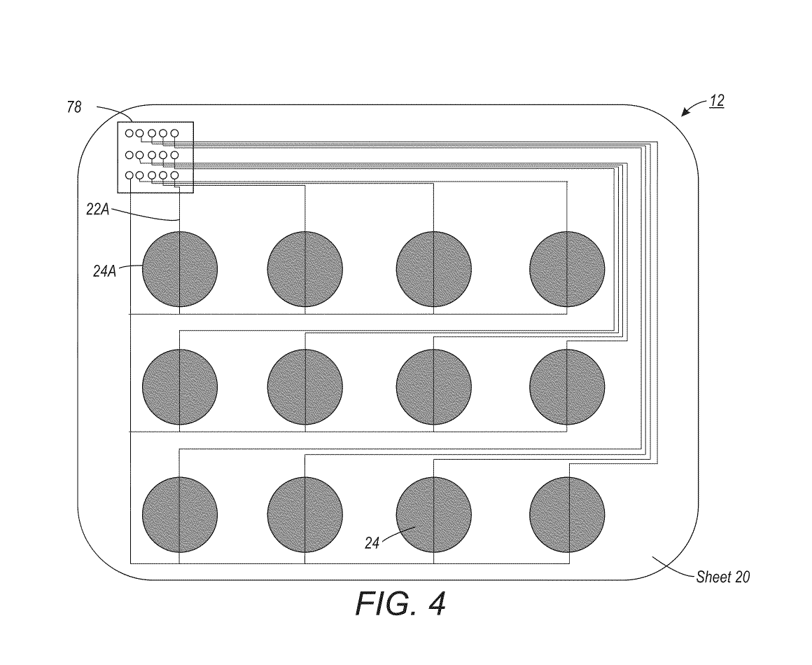

FIG. 4 is a pictorial representation of an example medication package for computer-based reusable bidirectional medical adherence system 10 for personalized medication packaging of FIGS. 1A and 1B. The following should be viewed in light of FIGS. 1 through 4. In FIG. 4, each portion 24 includes a separate circuit 22 connected to interface area 78. For example, portion 24A includes circuit 22A. Unit 14 engages the interface area to monitor circuits 22 as described above. For example, unit 14 can periodically transmit a low power pulse through those circuits still in operation to detect an increase in resistance associated with rupturing a respective portion 24 and opening the associated circuit 22. Unit 14 can be engaged with area 78 by simply slipping/pushing unit 14 onto area 78 using any means known in the art, such as a clip or compression fit. Unit 14 is reusable and can be used on another medication pack 12, for example, when MED in one medication pack is used up or the patient is otherwise instructed not to continue using the medication pack.

The following provides further detail regarding system 100 and the functionality of system 100 accessible via system 10. As noted above, system 100 includes at least one computer 102 with at least one memory element 104 and at least one processor 106. The memory element is configured to store computer readable instructions 108. The processor is configured to execute the computer readable instructions to receive medication regimen 110, for example, regimen 34, for patient P, formulated by medical practitioner MP or pharmacist PH. For example, the regimen is sent from computer-based device CP under the direction of MP or PH. The medication regimen includes instructions 112, for example, instructions 68 and 72, for taking medication MED1, for example, MED. In an example embodiment, instructions 112 include schedule 114, for example, schedule 42, for taking medication MED1 and dosage 116 for MED1. The processor is configured to execute the computer readable instructions to store the medication regimen in the memory element, generate at least one compliance message M1 regarding compliance with instructions 112, and generate, using the instructions 112, schedule 118 for transmitting message M1 to device D, for example, unit 14 or communications device 56, accessible by the patient. The processor is configured to execute the computer readable instructions to receive response 120 that MED1 has been made available to a patient, and to transmit, according to schedule 118, message M1 for receipt by the patient.

In an example embodiment, the processor is configured to execute the computer readable instructions to receive input 122 with data 124 regarding the patient, and to modify schedules 114 and 118 according to data 124. In an example embodiment, data 124 includes a schedule of daily activities for the patient, information regarding an exercise or therapy regimen for the patient, information regarding a second medication being taken by the patient, information regarding a meal schedule for the patient, or information regarding dietary restrictions for the patient. Thus, the schedule for taking MED1 and the schedule for sending message M1 is tailored to the specific circumstances and requirements of the patient. For example, the meal schedule may indicate that the patient normally eats breakfast at 7 AM and accordingly, schedule 114 is modified to include taking a medication at 8 AM, and schedule 118 is modified to send M1 at 8:30 AM.

In an example embodiment, the processor is configured to execute the computer readable instructions to receive response 126 from the patient indicating that the patient has taken MED1 according to instructions 112. For example, in response to receiving message M1, the patient sends response 126, indicating that the patient has taken MED1 according to instructions 112. Thus, system 100 enables automatic tracking of compliance of the patient with instructions 112. In an example embodiment, the processor is configured to execute the computer readable instructions to update respective electronic medical records system 128 for the medical practitioner or pharmacist to indicate that the patient has taken MED1 according to instructions 112. For example, system 128 could be in a computer CP associated with the MP and/or the PH.

In an example embodiment, the processor is configured to execute the computer readable instructions to generate time T by which to receive response 126. If the response is not received by time T, the processor transmits message M2 to the medical practitioner, pharmacist, or designated care-giver DCG for the patient indicating that response 126 was not received by time T. Thus, system 100 automatically alerts the appropriate parties when the patient has failed to provide response 126, which may indicate a problem with the patient or lack of compliance with instructions 112.

In an example embodiment, the processor is configured to execute the computer readable instructions to receive response 130, for example, message 64, from the patient indicating that the patient has not taken MED1 according to instructions 112, and to transmit message M3, indicating that the patient has not taken MED1 according to instructions 112, to the medical practitioner, pharmacist or DCG. In an example embodiment, the processor is configured to execute the computer readable instructions to update electronic medical records system 128 to indicate that the patient has not taken MED1 according to instructions 112. In an example embodiment, the processor is configured to execute the computer readable instructions to store, in the at least one memory element, information regarding DCG.

In general, non-compliance with the medication regimen can take two forms: not taking the right dosage and not taking a dosage at the scheduled time. For example, a patient on a blood pressure regulating medication could take less than the prescribed amount of the medication or could fail to take the medication at the prescribed time. Both of these instances would impair the effectiveness of the medication regimen. As another example, a patient on a pain medication could take more than the prescribed amount of the medication or could take the medication more frequently than prescribed. Both of these instances could be harmful to the patient.

In an example embodiment, the processor is configured to execute the computer readable instructions to transmit message M4, in response to receiving response 130 from the patient, for receipt by the patient, for example, by unit 14. M4 includes an option for the patient to request assistance, or an option for the patient to indicate that the patient does not wish to or cannot take MED1. M4 can be coordinated with options 60 and 62.

In an example embodiment, the processor is configured to execute the computer readable instructions to receive input 132 from the doctor or the pharmacist and after receipt of response 130, to modify, using input 132, instructions 112. In an example embodiment, the modifications are transmitted to unit 14, for example, transmission 74 is used to modify instructions 72. The processor modifies message M1 based on modified instructions 112 and transmits modified message M1 for receipt by the patient. Thus, system 100 enables a dynamic approach that adapts to on-going conditions. For example, in response to learning that a patient has missed taking MED1 at the prescribed time, MP can supply input 132 with appropriate instructions used by system to modify a time for taking MED1 and/or a dosage of MED1. The system then automatically formulates the appropriate message 116 and transmits the message to the patient.

In an example embodiment, system 100 automatically adjusts instructions 112 based on input 132 and content of response 130. For example, M1 includes a plurality of options 133 regarding compliance with the regimen and possible problems facing the patient. Input 132 includes appropriate and executable responses to options 133, for example, look-up table 136, for the conditions. Response 130 includes selection of one or more of the options and the processor is configured to select an appropriate entry from table 136 to address the selected option. For example, the content of message M3 of M4 can include information from the table.

In an example embodiment, schedule 114 includes a plurality of points in time at which the patient is to take MED1. The processor is configured to execute the computer readable instructions to generate schedule 120 by determining at least one respective time interval TI and generating each point in schedule 120 by adding a respective TI to a respective point in time from schedule 114. For example, schedule 114 includes times 9 AM and 4 PM at which the patient is to take MED1. The system determines that 20 and 30 minutes are appropriate TIs, for example, based on input 122, and adds 20 and 30 minutes to 9 AM and 4 PM, respectively, to generate two points in time at which message 116 is to be transmitted.

System 100 can be used with a plurality of medications. In an example embodiment, the medication regimen includes instructions 138 for taking a medication MED2, different from MED1. In a manner similar to that described for MED1, the processor is configured to execute the computer readable instructions to generate at least one compliance message M5 regarding compliance with instructions 138 and generate, using instructions 138, schedule 140 for transmitting message M5. The processor is configured to execute the computer readable instructions to receive response 142 that MED2 has been made available to the patient and transmit, according to schedule 140, message M5 for receipt by the patient.

In general, the discussion above regarding MED1 and system 100 is applicable to any other medication, such as MED2, being taken by the patient. For example, the processor is configured to receive response 144, similar to response 126, from the patient stating that the patient has or has not taken MED2 according to instructions 138. In an example embodiment, in response to receipt of response 144, the processor is configured to transmit message M6, similar to M2 or M3, indicating that the patient has or has not taken MED2 according to the instructions 138. In an example embodiment, in response to receipt of response 144, the processor is configured to update electronic medical records system 128 to indicate that the patient has or has not taken MED2 according to the instructions 138. Thus, system 100 is able to simultaneously perform the same functions described with respect to MED1 for a plurality of different medications.

The following provides further detail regarding system 100. Computer 102 can be any computer or plurality of computers known in the art. In an example embodiment, the computer is located in a single location, for example, at a pharmacy providing MED1. In an example embodiment, multiple computers 102 are located in different respective locations and are linked by any means known in the art. Thus, a patient may be in communication with a computer 102 associated with a pharmacy in their home town providing MED1. When the patient travels to a different area, communication and feedback regarding the patient's compliance with a regimen can be implemented via another computer 102 in a pharmacy in the different area.

In an example embodiment, computer 102 is centralized and communication among all patients, MPs and PHs in system 100 is via the centralized computer. This arrangement has the advantage of enabling communication and interaction between a patient and respective MPs or PHs regardless of the location of the patient and without the necessity of local computers 102.

Memory element 104 can be any memory element known in the art. Processor 106 can be any processor known in the art. In an example embodiment, the memory element is separate from computer 102 and is linked to computer 102 by any means known in the art. Computer-based device CP can be any computer-based device known in the art.

Device D can be any suitable communication device known in the art. Communication between device D and computer 102 can be implemented by any means known in the art. In an example embodiment, communication between computer 102 and the patient is in real time, for example, device D is immediately accessible by the patient. In an example embodiment, D is any WCD known in the art, for example WCD1. For example, WCD1 is a cellular telephone or computer in possession of the patient, message M1 is transmitted in real time to the cellular telephone or computer at the time specified in schedule 118, and the patient is able to provide response 120 in real time using the telephone or computer. For example, a patient does not have to wait until a scheduled appointment to provide compliance information to an MP or to ask for help from the MP.

In an example embodiment, computer 102 is an Internet-based server or is linked to an Internet web site. Devices CP and D are Internet Devices or Internet Enabled Devices.

In an example embodiment, communication between a patient and computer 102 can be implemented via an Internet connection with a hard wired computer in possession of the patient, for example, a computer with a cable or DSL connection. For example, message M1 is made available on a website in real time according to schedule 118 and the patient logs into a website to receive M1 and provide response 120. If the patient is not in possession of a device with an Internet connection, message M1 can be posted, according to schedule 118, at a website that can be accessed by the patient, for example, at a café with a wireless Internet connection or at a computer at a pharmacy providing a medication.

System 100 enables real time communication between a patient and a medical practitioner or pharmacist and is personalized to meet the needs of the patient on a medication regimen. System 100 can be used with a personalized medication packaging system as described in U.S. Pat. No. 7,454,880, the disclosure of which is incorporated herein by reference in its entirety. When a medication is packaged, the medication container is specifically designed for the particular patient's specific drug regimen. In an example embodiment, system 100 adds value for the patient by identifying the medications being taken and providing information on or with the container that will help the customer to learn more about their particular condition and its possible prevention or cure. For example, message M1 and instructions 112 can include not only a prompt to take a dosage and to report compliance or problems, but also can include information about the condition being treated by the medication and other measures the patient can take to treat or alleviate the condition, such as dietary or life style changes. Along this line, recipe suggestions geared towards improving the patient's condition can be provided. Other useful information such as possible side-effects and special instructions such as how to take the dosage with respect to other medications or meals can be provided.

In an example embodiment, system 100 also adds value by automatically identifying and providing links to personalized videos applicable to the specifics of the patient's condition. For example, listing 146 of such links is stored in the memory element and the processor is configured to parse the medication regimen to identify links appropriate to the medication and condition in question and transmit the identified links to the patient, for example, in message M1. In an example embodiment, URLs or phone numbers to support groups for the patient or the patient's family are provided, for example with message M1 or in reply to a response from the patient.

System 100 further enables support for the patient. In an example embodiment, encouragement is provided to the patient. Well wishes from friends, family and other supporters are assembled from input 148 received by system 100, for example, via a portal at the pharmacy providing medication to the patient, Facebook, or a mobile application for a WCD, and transmitted to the patient, for example, in message M1. In an example embodiment, discount coupons for items that the customer may need, not only based on the current condition, but past buying habits are provided. Such information could be provided on an opt-in basis to honor the privacy of the patient.

Thus, the patient receives a personalized package of medications and is expected to comply with a medication regimen including a schedule for the taking the medications and respective dosages of the medication. System 100 provides a highly personalized reminder system in which the patient can enroll. The system is personalized, for example by the mode of communication with which the customer is notified, such as text message, mobile phone application, non-internet connected application (messages posted on a website to be accessed at the patient's convenience), email, telephone call or any other communication avenue.

The patient can easily change the mode of communication according to desire, need, or changing circumstances. For instance, a patient can switch from interfacing with system 100 by cellular telephone to a non-internet connected mobile application when the customer is out of range of cell towers. In addition to the mode of communication, the customer can select the tone of the messages received. For instance, message M1 may be a gentle reminder, a stem or authoritarian reminder, or a humorous reminder. Depending on the mode of communication, additional information can be provided to the patient similar to that which was printed on the original packaging.

As described above, In an example embodiment to close the customization loop, system 100 enables the patient to notify a medical practitioner or pharmacist/pharmacy system when the patient has taken their medication. For example, in reply to message M1, the patient transmits response 126. As noted above, responses 126 and 130 can be sent to medical records system 128 to update the system as to compliance of the patient with the regimen. In this manner, the medical practitioner prescribing the medication is keep up to date, a key feature of a patient-centric system. In an example embodiment, respective medical records systems 128 for other medical practitioners or pharmacists involved in the care the patient are updated as well.

In response to the automatic receipt of response 130 (non-compliance with the medication regimen), the prescribing MP or the PH have the opportunity to make timely adjustments to the regimen or to modify instructions 112, or system 100 can make automatic adjustments. For example, upon receipt of response 130, message M7 can be sent in real time to the MP alerting the MP as to the non-compliance. In an example embodiment, message M1 includes options to which the patient responds and which identify the nature of the non-compliance. The options are then included in response 130 and message M7. Based on the real time information, the MP can provide input 122, for example, changing schedule 114 or an amount of the medication for the next scheduled dosage. Input 122 can be included in transmission 74. If the patient is having problems or requests help, response 130 can include information regarding the problems or simply a request for the MP of PH to contact the patient.

Thus, possible problems are identified immediately and can be dealt with in a timely fashion, minimizing possible negative effects of the problems. For example, based on the input from the patient the medication regimen can be modified to include a different type or dosage of medication, or a discussion with the patient can be scheduled to determine why the patient is not taking the medication. Access to the complete regimen may enable substitution of any of the medications that interfere with the others, providing more options than are available with the provider's knowledge of only his/her directly prescribed medications.

In an example embodiment, to encourage compliance, the patient can earn customized rewards based on the timeliness of both taking their medication (as ascertained by responses 126) and obtaining refills. For example, system 100 tracks refill activity and stores refill information 150 regarding the refill activity in the memory element. Thus, the “gamification” aspect of system 100 is highly personalized and is integrated with the overall knowledge base of the system.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based system for implementing and monitoring a medication regimen, comprising:
a medication package including:
a base including a plurality of spaces for receiving at least one medication;
a sheet of material including respective portions sealing the plurality of spaces with respect to the base; and,
a respective electrical circuit associated with each respective portion; and,
a computer-based unit including:
a memory element configured to store first computer readable instructions and a medication regimen, formulated by a medical practitioner or pharmacist, for the at least medication;
a processor; and,
a wireless transmitter, wherein:
the computer-based unit is attachable to the medication package or can wirelessly communicate with the medication package; and,
the processor is configured to execute the first computer readable instructions to:
monitor the respective electrical circuits to detect when the respective portions are ruptured; and,
wirelessly transmit, using the wireless transmitter, a compliance message for receipt by at least one computer, the compliance message indicating whether a respective portion has been ruptured.

2. The computer-based system of claim 1, wherein:
monitoring the respective electrical circuits to detect when the respective portions are ruptured includes detecting, in real time, when the respective portions are ruptured; or,
wirelessly transmitting the compliance message includes wirelessly transmitting the compliance message in real time in response to detecting when the respective portions are ruptured.

3. The computer-based system of claim 1, wherein:
the computer-based unit includes a wireless receiver; and,
the processor is configured to execute the first computer readable instructions to:
receive, using the wireless receiver, the medication regimen; and,
store the medication regimen in the first memory element.

4. The computer-based system of claim 1, wherein:
the medication regimen is encoded on the medication package; and,
the processor is configured to execute the first computer readable instructions to:
download the encoded medication regimen from the medication package; and,
store the medication regimen in the first memory element.

5. The computer-based system of claim 1, wherein:
the at least one medication regimen includes a schedule with respective times for taking the at least one medication enclosed in respective specified spaces; and,
the compliance message includes information as to whether the respective portion was ruptured according to the schedule.

6. The computer-based system of claim 5, wherein:
the information indicates whether: the respective portion was ruptured for a correct respective space and at a correct time according to the schedule, the respective portion was ruptured prior to a first time according the schedule, the respective portion was ruptured after a second time according to the schedule, or the respective portion was for an incorrect space according to the schedule;
prior to the first time indicates taking the at least one medication sooner than directed according to the schedule;
after the second time indicates taking the at least one medication later than directed according to the schedule; and,
the incorrect space indicates an incorrect configuration of the at least one medication.

7. The computer-based system of claim 1, wherein:
the at least one computer includes a second memory element configured to store second computer readable instructions, and at least one processor,
the processor is configured to execute the first computer readable instructions to transmit, using the user interface, a first message to the at least one computer regarding non-compliance with the medication regimen; and,
the at least one processor is configured to execute the second computer readable instructions to transmit, in response to receiving the first message, a second message, regarding the non-compliance with respect to the medication regimen, to a communications device accessible by a patient for whom the at least one medication has been prescribed.

8. The computer-based system of claim 1, wherein:
the computer-based unit includes a user interface; and,
the processor is configured to execute the first computer readable instructions to:
provide, using the user interface, a first option to request assistance, or a second option informing the medical practitioner or pharmacist of a lack of desire or inability to take the at least one first medication;
receive, using the user interface, election of the first or second option; and,
transmit, using the wireless transmitter, a message, including the first or second selected option, to the at least first one computer.

9. The computer-based system of claim 8, wherein:
the computer-based unit includes a wireless receiver; and,
the processor is configured to execute the first computer readable instructions to:
receive a transmission from the at least one computer in response to transmitting the message, the transmission including a response to the message; and,
express, using the user interface, the transmission.

10. The computer-based system of claim 1, wherein:
the medication regimen includes instructions regarding the at least one first medication;
the computer-based unit includes a user interface; and,
the processor is configured to execute the first computer readable instructions to express, using the user interface, a message based on the instructions.

11. The computer-based system of claim 1, wherein:
the at least one medication regimen includes a schedule with respective times for taking the at least one medication enclosed in respective specified spaces; and,
the processor is configured to execute the first computer readable instructions to express the message according to the schedule.

12. The computer-based system of claim 1, wherein:
the medication regimen includes instructions regarding the at least one first medication;
the computer-based unit includes a wireless receiver; and,
the processor is configured to execute the first computer readable instructions to:
receive, using the wireless receiver, a transmission from the at least one computer; and,
modify the instructions according to the transmission.

13. The computer-based system of claim 12, wherein:
the computer-based unit includes a user interface; and,
the processor is configured to execute the first computer readable instructions to express, using the user interface, a message based on the modified instructions.

14. The computer-based system of claim 1, wherein the processor is configured to execute the first computer readable instructions to wirelessly transmit, using the wireless transmitter, the compliance message to a respective electronic medical records system for the medical practitioner or pharmacist.

15. The computer-based system of claim 1, wherein the at least one computer is associated with the medical practitioner, the pharmacist, or a designated care giver for a patient for whom the at least one medication is prescribed.

16. A computer-based method for implementing and monitoring a medication regimen, comprising:
storing in a memory element for a computer-based unit, first computer readable instructions and a medication regimen, formulated by a medical practitioner or pharmacist, for the at least medication;
sealing, with respective portions of a sheet of material, the at least one medication in a plurality of spaces in a base for a medication package;
associating respective electrical circuits with the respective portions; and,
executing, using a processor for the computer-based unit, the first computer readable instructions to:
monitor the respective electrical circuits to detect when the respective portions are ruptured; and,
wirelessly transmit, using a wireless transmitter for the computer-based unit, a compliance message for receipt by at least one computer, the compliance message indicating whether a respective portion has been ruptured.

17. The computer-based method of claim 16, wherein:
monitoring the respective electrical circuits to detect when the respective portions are ruptured includes detecting, in real time, when the respective portions are ruptured; or,
wirelessly transmitting the compliance message includes wirelessly transmitting the compliance message in real time in response to detecting when the respective portions are ruptured.

18. The computer-based method of claim 16, wherein the computer-based unit includes a wireless receiver, the method further comprising executing, using the processor, the first computer readable instructions to:
receive, using the wireless receiver, the medication regimen; and,
store the medication regimen in the first memory element.

19. The computer-based method of claim 16, wherein the medication regimen is encoded on the medication package, the method further comprising executing, using the processor, the first computer readable instructions to:
download the encoded medication regimen from the medication package; and,
store the medication regimen in the first memory element.

20. The computer-based method of claim 16, wherein:
the at least one medication regimen includes a schedule with respective times for taking the at least one medication enclosed in respective specified spaces; and,
the compliance message includes information as to whether the respective portion was ruptured according to the schedule.

21. The computer-based method of claim 20, wherein:
the information indicates whether: the respective portion was ruptured for a correct respective space and at a correct time according to the schedule, the respective portion was ruptured prior to a first time according the schedule, the respective portion was ruptured after a second time according to the schedule, or the respective portion was for an incorrect space according to the schedule;
prior to the first time indicates taking the at least one medication sooner than directed according to the schedule;
after the second time indicates taking the at least one medication later than directed according to the schedule; and,
the incorrect space indicates an incorrect configuration of the at least one medication.

22. The computer-based method of claim 16, wherein the at least one computer includes a second memory element configured to store second computer readable instructions, and at least one processor the method further comprising:
executing, using the processor, the first computer readable instructions to transmit, using the user interface, a first message to the at least one computer regarding non-compliance with the medication regimen; and,
executing, using the at least one processor, the first computer readable instructions to transmit, in response to receiving the first message, a second message, regarding the non-compliance with respect to the medication regimen, to a communications device accessible by a patient for whom the at least one medication has been prescribed.

23. The computer-based method of claim 16, wherein the computer-based unit includes a user interface, the method further comprising executing, using the processor, the first computer readable instructions to:
provide, using the user interface, a first option to request assistance, or a second option informing the medical practitioner or pharmacist of a lack of desire or inability to take the at least one first medication;
receive, using the user interface, election of the first or second option; and,
transmit, using the wireless transmitter, a message, including the first or second selected option, to the at least first one computer.

24. The computer-based method of claim 23, wherein the computer-based unit includes a wireless receiver, the method further comprising executing, using the processor, the first computer readable instructions to:
receive a transmission from the at least one computer in response to transmitting the message, the transmission including a response to the message; and,
express, using the user interface, the transmission.

25. The computer-based method of claim 16, wherein:
the medication regimen includes instructions regarding the at least one first medication; and,
the computer-based unit includes a user interface, the method further comprising executing, using the processor, the first computer readable instructions to express, using the user interface, a message based on the instructions.

26. The computer-based method of claim 16, wherein the at least one medication regimen includes a schedule with respective times for taking the at least one medication enclosed in respective specified spaces, the method further comprising executing, using the processor, the first computer readable instructions to express the message according to the schedule.

27. The computer-based method of claim 16, wherein:
the medication regimen includes instructions regarding the at least one first medication; and,
the computer-based unit includes a wireless receiver, the method further comprising executing, using the processor, the first computer readable instructions to:
receive, using the wireless receiver, a transmission from the at least one computer; and,
modify the instructions according to the transmission.

28. The computer-based method of claim 27, wherein the computer-based unit includes a user interface, the method further comprising executing, using the processor, the first computer readable instructions to express, using the user interface, a message based on the modified instructions.

29. The computer-based method of claim 16, further comprising executing, using the processor, the first computer readable instructions to wirelessly transmit, using the wireless transmitter, the compliance message to a respective electronic medical records system for the medical practitioner or pharmacist.

30. The computer-based method of claim 16, wherein the at least one computer is associated with the medical practitioner, the pharmacist, or a designated care giver for a patient for whom the at least one medication is prescribed.

31. A computer-based system for implementing and monitoring a medication regimen, comprising:
a medication package including:
a base including a plurality of spaces for receiving at least one medication;
a sheet of material including respective portions sealing the plurality of spaces with respect to the base; and,
a respective electrical circuit associated with each respective portion; and,
a computer-based unit including:
a memory element configured to store first computer readable instructions;
a processor; and,
a wireless transmitter and receiver, wherein:
the computer-based unit is attachable to the medication package or can wirelessly communicate with the medication package; and,
the processor is configured to execute the first computer readable instructions to:
download, from scan code or a radio frequency identification tag on the medication package, a medication regimen for the at least one medication, formulated by a medical practitioner or pharmacist and including a schedule with respective times for taking the at least one medication enclosed in respective specified spaces;
store the medication regimen in the memory element;
monitor the respective electrical circuits to detect, in real time, when the respective portions are ruptured; and,
wirelessly transmit in real time, using the wireless transmitter, a compliance message for receipt by at least one computer, the compliance message information as to whether the respective portion was ruptured according to the schedule.

32. A computer-based method for implementing and monitoring a medication regimen, comprising:
storing in a memory element for a computer-based unit, computer readable instructions and a medication regimen, formulated by a medical practitioner or pharmacist, for at least one medication, the medication regimen including instructions regarding the at least one medication;
sealing, with respective portions of a sheet of material, the at least one medication in a plurality of spaces in a base for a medication package;
associating respective electrical circuits with the respective portions; and,
executing, using a processor for the computer-based unit, the computer readable instructions to:
express, using a user interface for the computer-based unit, a first message based on the instructions;
receive, using a wireless receiver for the computer-based unit, a transmission from at least one computer;
modify the instructions according to the transmission;
express, using the user interface, a second message based on the modified instructions;
monitor the respective electrical circuits to detect when the respective portions are ruptured; and,
wirelessly transmit, using a wireless transmitter for the computer-based unit, a compliance message for receipt by the at least one computer, the compliance message indicating whether a respective portion has been ruptured.
